(19) United States
(12) Patent Application Publication
(10) Pub. No.: US 2008/0310707 A1
(43) Pub. Date: Dec. 18, 2008

(54) VIRTUAL REALITY ENHANCEMENT USING REAL WORLD DATA

(75) Inventors: Aman Kansal, Issaquah, WA (US); Eric J. Horvitz, Kirkland, WA (US); Feng Zhao, Issaquah, WA (US)

Correspondence Address: LEE & HAYES PLLC, 421 W RIVERSIDE AVENUE SUITE 500, SPOKANE, WA, 99201, US

(73) Assignee: MICROSOFT CORPORATION, Redmond, WA (US)

(21) Appl. No.: 11/764,120

(22) Filed: Jun. 15, 2007

(51) Int. Cl. G06K 9/36

(52) U.S. Cl. 382/154

(57) ABSTRACT

Techniques for enhancing virtual reality using transformed real world data are disclosed. In some aspects, a composite reality engine receives a transmission of the real world data that is captured by embedded sensors situated in the real world. The real world data is transformed and integrated with virtual reality data to create a composite reality environment generated by a composite reality engine. In other aspects, the composite reality environment enables activation of embedded actuators to modify the real world from the virtual reality environment. In still further aspects, techniques for sharing sensors and actuators in the real world are disclosed.

### BACKGROUND

Virtual reality environments provide simulated three-dimensional spaces for applications such as single or multi-player computer games. Artificial representations exist within these virtual reality environments and may resemble features of the real world. A virtual reality environment may include representations of real people, places, and objects. For example, a virtual reality environment may include an avatar representing a real life player in a game who is featured in a virtual location that includes characteristics of the real world such as landmarks, buildings, and other objects.

The virtual reality environments are often disconnected from real world objects, states, events, and information. For example, when a physical change occurs in the real world, such as an environmental change triggered by people, weather, or nature, it is not typically reflected in the virtual reality environment without a release of an updated or new version of an application providing the virtual reality environment. In addition, virtual reality environments typically do not enable users to make changes to remote locations in the real world, thus isolating actions in the virtual reality environment from events in the real world.

Virtual reality environments are also often physically disconnected from the real world because they lack interconnectivity with available remote inputs. For example, remote inputs may provide added content or improve the conceptual or geographical accuracy of the virtual reality environment. A virtual reality environment disconnected from remote inputs may be less realistic.

Virtual reality environments that closely model aspects of the real world are typically expensive to create. The elements of a virtual reality environment, including artificial scene textures and realistic objects, referred to as game art, typically have large costs associated with their creation, production, and various representations. Artists often create game art by manually developing objects and images in the virtual reality environment.

Accordingly, there is a continuing need to improve how virtual environments are created and updated to enhance user experience.

### SUMMARY

This summary is provided to introduce simplified concepts of enhancing virtual reality using real world data, which is further described below in the Detailed Description. This summary is not intended to identify essential features of the claimed subject matter, nor is it intended for use in determining the scope of the claimed subject matter.

Exemplary techniques for enhancing virtual reality using real world data are disclosed herein. Various exemplary techniques allow a user to experience aspects of both the real world and a virtual reality environment in a composite reality environment. In one aspect, sensors are provided to capture real world data for use in the composite reality environment or for storage in a database. The real world data is transformed and integrated with virtual reality data to form a composite reality environment that exhibits increased realism. Further, such techniques may reduce the cost of creating a virtual reality environment. Various exemplary techniques may also include providing actuators for interacting with the real world from a virtual reality environment. Techniques for sharing resources, such as sensors and actuators, are also disclosed.

### BRIEF DESCRIPTION OF THE DRAWINGS

The detailed description is described with reference to the accompanying figures. In the figures, the left-most digit(s) of a reference number identifies the figure in which the reference number first appears. The same reference number in different figures refers to similar or identical items.

FIG. 1 illustrates an exemplary architecture in which a virtual reality environment may be enhanced by real world data.

FIG. 2 is a block diagram illustrating an exemplary composite reality engine for enhancing the virtual reality environment with real world data.

FIG. 3 is a flow diagram illustrating an exemplary method of using sensors to analyze and transform aspects of the real world and enhance the realism of the virtual reality environment.

FIG. 4 is a flow diagram illustrating an exemplary method of using sensors to obtain real world data that may be transformed or otherwise incorporated with the virtual reality environment.

FIG. 5 is flow diagram illustrating an exemplary method of providing an interactive composite reality environment including aspects of the real world and the virtual reality environment.

FIG. 6 is a flow diagram illustrating an exemplary method of providing actuators to manipulate aspects of the real world and enhance the realism of the virtual reality environment.

FIG. 7 is a flow diagram illustrating an exemplary method of providing sensors and actuators in the real world for use with a composite reality engine, and recording associated data in a database.

### DETAILED DESCRIPTION

Overview:

The following disclosure describes techniques for enhancing virtual reality environments using real world data to produce a composite reality environment. Sensing technology may be used to capture real world data from remote locations in the real world. The composite reality environment may then render the virtual reality environment with the real world data. The real world data may be obtained from locations remote from users interacting in the composite reality environment. For example, embedded sensing technology can capture objects, states, events, and information from the real world that can be applied in the composite reality environment. A user interacting in the composite reality environment may experience many features of the real world while simultaneously benefiting from the features of the virtual reality environment. The integration of the real world data increases the realism of the virtual reality environment when presented in the composite reality environment. The composite reality environment may be used, for example, in online gaming, role-playing, and simulation applications.

An environment in which the techniques may enable these and other actions is set forth below in the Exemplary Environment section. This section is followed by the Exemplary Composite Reality Engine section, describing the techniques in greater detail. The next section, Composite Reality Example, describes one exemplary way in which the techniques may act in conjunction with a composite reality engine. The final section, Alternative Embodiments, describes various other embodiments and manners in which the techniques may act, such as in conjunction with other databases, virtual reality modules, or other environments. This overview is provided for the reader's convenience and is not intended to limit the scope of the claims or the entitled sections.

Exemplary Environment:

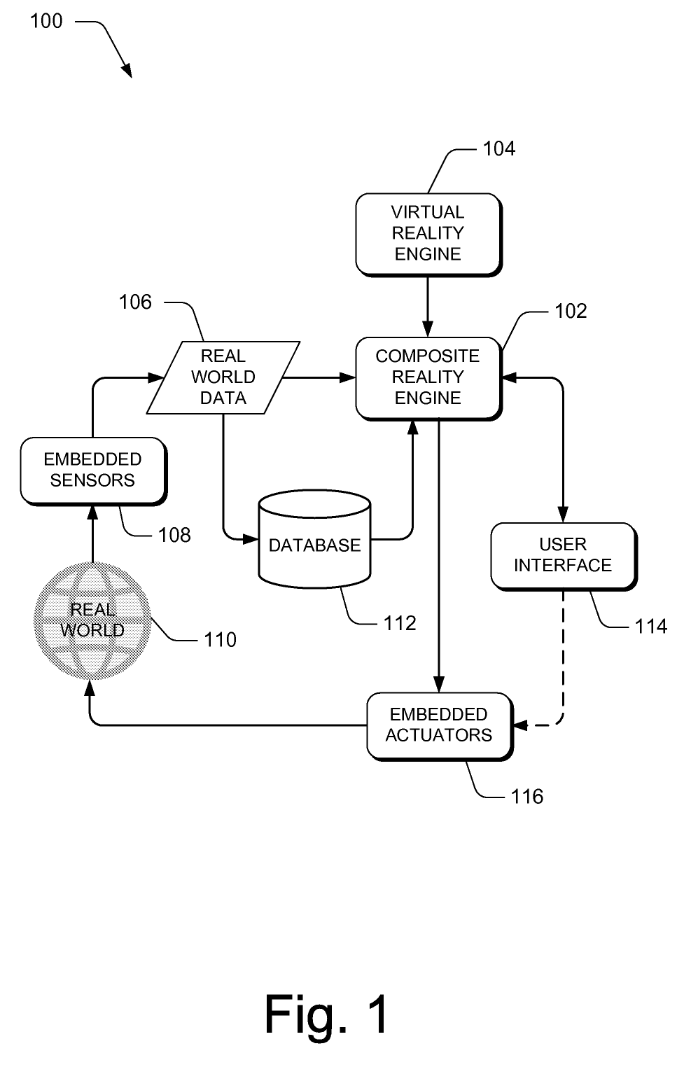

FIG. 1 shows an exemplary architecture 100 for enhancing virtual reality environments with real world data. The architecture 100 includes a composite reality engine 102 for creating a composite reality environment. The composite reality environment may be used by an online computer game, role-playing application, simulator application, or similar application. The composite reality engine 102 combines output from a virtual reality engine 104 with real world data 106 to produce a composite reality environment. The composite reality environment includes aspects of both a virtual reality environment produced by the virtual reality engine 104 and the real world data 106.

The virtual reality engine 104 generates the virtual reality environment, such as simulated three-dimensional environments in a computer game. For example, the virtual reality engine 104 may create a virtual reality landscape of an actual city, including replications of actual buildings and features of the city, but without incorporating real world data 106 (e.g., sensor based data).

The architecture 100 further includes embedded sensors 108. The embedded sensors 108 consist of any number of sensors capable of observing the real world 110 and extracting real world data 106. The real world data 106 may include real world activities, changes to the real world 110 triggered by people, weather, nature, or any recordable and quantifiable aspect observed in the real world. The real world data 106 may be associated with time and location data.

The embedded sensors 108 may include a multiplicity of devices that observe the state of the real world 110, such as cameras, microphones, weather sensors such as temperature and humidity sensors, or other types of sensors that can capture the real world data 106. The embedded sensors 108 are placed in the world at locations relevant to measuring appropriate environmental data, possibly far beyond the user's vicinity and are not typically managed by physical interaction with a local user. Instead, users interact with the embedded sensors 108 through the composite reality environment 102. The embedded sensors 108 may be configured to capture real world data 106 in remote locations spread across the real world 110, including locations underwater, on land, in the earth's atmosphere, or in space.

In one embodiment, the embedded sensors 108 may capture the real world data 106 which may then be used in real time by the composite reality engine 102. For example, the composite reality engine 102 may be in communication with the embedded sensors 108 to receive the real world data 106. The real world data 106 may be provided in the composite reality environment in a real-time application, near real-time application, or archived occurrence.

In another embodiment, the real world data 106 collected by the embedded sensors 108 may be stored in a database 112 in communication with the composite reality engine 102. The composite reality engine 102 may extract real world data 106 captured by the embedded sensors 108 by retrieving information from the database 112. For example, in instances when real world data 106 is not used in a real-time application, or when the real world data 106 is archived, the real world data 106 may be stored in the database 112 for later extraction by the composite reality engine 102.

The database 112 may be a storage server or other type of data storage device that retains some or all of the real world data 106. The database 112 may store objects, states, events, and information such as temperature, precipitation levels, humidity, light levels, colorization, textures, images, and other data from the real world 110 captured by the embedded sensors 108. In another embodiment, more than one database may be used to store real world data 106 captured by the embedded sensors 108. For example, the embedded sensors 106 may not be owned or operated by a common entity and may require data to be stored in more than one database 112.

A user interface 114 allows a user to interact with the composite reality environment created by the composite reality engine 102. The user interface 114 may consist of electronic displays, keyboards, joysticks or specialized hardware within a proximity of the user that allow the user to interact with objects in the composite reality world. By interacting through the user interface 114, the user may experience aspects of both the virtual reality environment and the real world by exploring and modifying the composite reality environment produced by the composite reality engine 102.

In some embodiments, the user interface 114 may enable the user to control embedded actuators 116. The embedded actuators 116 may consist of one or more devices located anywhere in the real world 110 and configured to modify one or more aspects of the real world. The embedded actuators 116 may include mechanical or electrical mechanisms, motors, speakers, lights, or other controllable devices capable of modifying the real world 110. For example, a user interacting in the composite reality environment may control an embedded actuator 116, such as an electric motor, to change a position of an object in the real world.

The embedded actuators 116 may also affect real world data 106 captured by the embedded sensors 108. For example, a user may control an embedded actuator 116 in the composite reality environment and observe a change in the real world 110 that is captured by an embedded sensor 108 and then presented in the composite reality environment. In some embodiments, the embedded actuators 116 may be integrated with the embedded sensors 108 in a single device. Similar to the embedded sensors 108, the embedded actuators 116 may be owned or operated by separate entities and may be located anywhere in the real world 110.

Exemplary Composite Reality Engine:

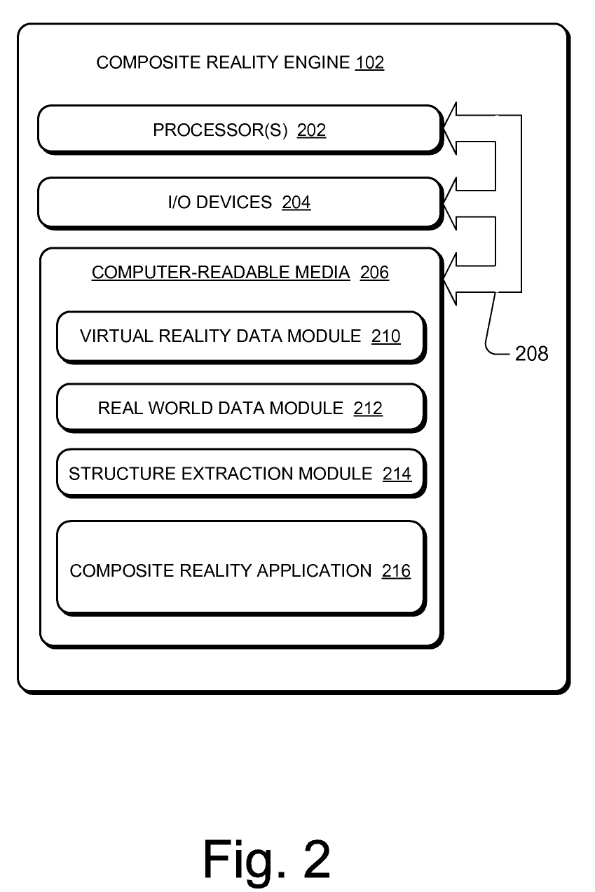

FIG. 2 illustrates various components of an exemplary composite reality system 200 suitable for creating a composite reality environment. Although the composite reality system 200 may include some or all of the elements described in FIG. 1, the system is described below with reference to the composite reality engine 102. The composite reality engine 102 may include, but is not limited to, a processor 202, Input/Output (I/O) devices 204, one or more computer-readable media 206, and a system bus 208 that operatively couples various components including the processor 202 to the computer-readable media 206.

The computer-readable media 206 may include computer-readable media in the form of volatile memory, such as Random Access Memory (RAM) and/or non-volatile memory, such as Read Only Memory (ROM) or flash RAM. The computer-readable media 206 typically includes data and/or program modules for generating a composite reality environment that is immediately accessible to (and/or presently operated on) the processor 202. In embodiments, the computer-readable media 206 may include a virtual reality data module 210, a real world data module 212, a structure extraction module 214, and a composite reality application 216

The virtual reality data module 210 may include virtual reality data such as 3-D virtual models, software, or program instructions necessary to generate the virtual reality environment. The virtual reality data module 210 may be in communication with a separate device, computer, server, or other data distribution device to receive the virtual reality data. The virtual reality data module 214 may include a fully rendered virtual reality environment, such as those already common in the art, which include only aspects of the virtual reality environment. For example, the virtual reality data module may generate a virtual building with walls shaded based on instructions from the virtual reality engine.

The real world data module 212 may receive real world data 106 from the embedded sensors 108 either directly from the embedded sensors 108 or through an intermediary such as the database 112. The real world data module 212 may retain the real world data 106 recorded by the sensors 108. In other embodiments, the real world data module 212 may transform the real world data 106 captured by the embedded sensors 108 for implementation into the composite reality environment. For example, the real world data 106 may include colorization information captured by embedded sensors 108 in the real world 110. The real world data module 212 may transform the colorization information into several color shades. As further explained below, this information may then be used by the composite reality application 216.

The structure extraction module 214 provides the algorithms and architecture for combining and manipulating the virtual reality environment from the virtual reality data module 210 and the real world data 106 from the real world data module 212. In an implementation, the structure extraction module 214 is a set of computer instructions for combining the data from the virtual reality data module 210 and the real world data module 212. In another implementation, the structure extraction module 214 may transform the data in the virtual reality data module 210, the real world data module 212, or both to create the composite reality environment. For example, the structure extraction module 214 may include algorithm and architecture to map the several color shades generated by the real world data module 212 with the building walls in the virtual reality data module 210 to create a composite reality building with aspects of both the virtual reality environment (i.e., the building and walls) with aspects of the real world (i.e., real colors as captured by the embedded sensors 108.)

The computer-readable media 206 may also include a composite reality application 216. The composite reality application 216 may create a composite reality environment by combining data from both the virtual reality data module 210 and the real world data module 212 using information provided by the structure extraction module 214. In some embodiments, the composite reality application 216 may generate an online computer game application where a user can navigate through a virtual reality environment enhanced with aspects from the real world 110 obtained by embedded sensors 108. For example, the composite reality application 216 may allow a user to navigate through a city in a composite reality environment. The city may include the building described above which includes walls that are shaded with colors sensed from the real world (as described above).

Generally, program modules executed on the components of the composite reality engine 102 include routines, programs, objects, components, data structures, etc., for performing particular tasks or implementing particular abstract data types. These program modules and the like may be executed as a native code or may be downloaded and executed such as in a virtual machine or other just-in-time compilation execution environments. Typically, the functionality of the program modules may be combined or distributed as desired in various implementations.

An implementation of these modules and techniques may be stored on or transmitted across some form of computer-readable media. Computer-readable media can be any available media that can be accessed by a computer. By way of example, and not limitation, computer-readable media may comprise computer storage media that includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium, which can be used to store the desired information and which can be accessed by a computer.

Composite Reality Example:

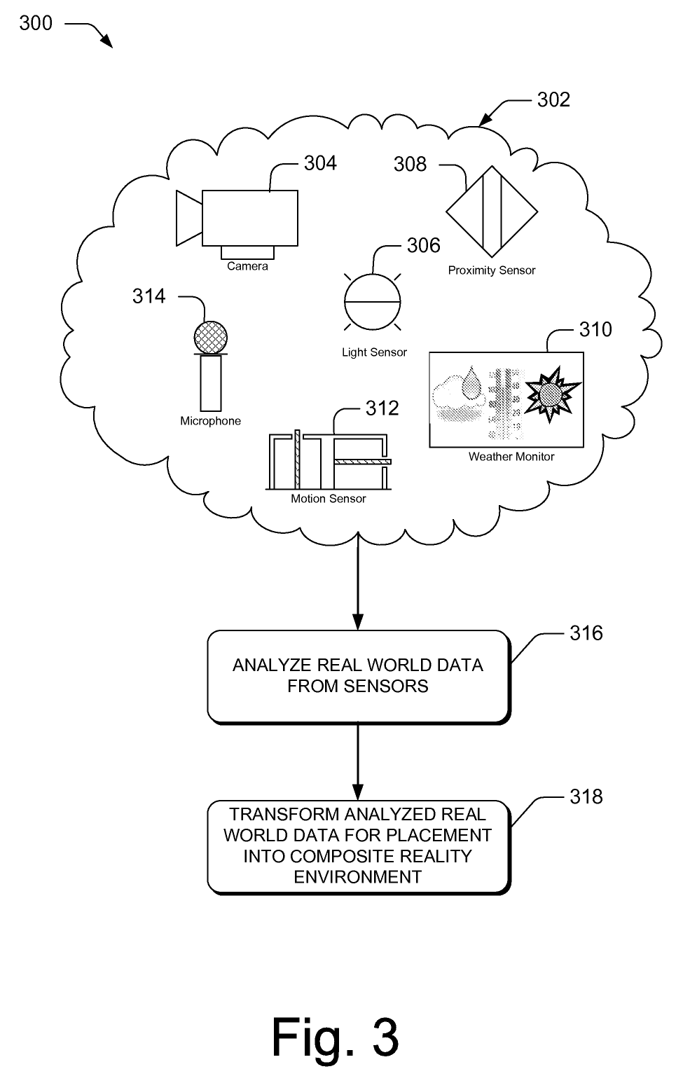

FIG. 3 illustrates a method 300 suitable for creating a composite reality environment, or, a virtual reality environment enhanced with real world data. The composite reality engine 202 uses the real world data 106 captured by the embedded sensors 108 to integrate aspects of the real world into the composite reality environment. In some embodiments, the real world data 106 may be transformed prior to integration into composite reality environment.

A collection of embedded sensors 302 may be used to record, measure, generate, obtain, or extract information from the real world 110. The embedded sensors 302 may include a camera 304, such as a video camera, a still photo camera, or an infrared camera. The camera 304 may capture entire images or portions of images, such as colors, light levels, or textures. For example, a remotely located consumer-grade digital camera may be used as a sensor, whereas the image created by the camera is analyzed (such as by the real world data module 212) for light levels and colorization, aspects which are then incorporated into the composite reality environment.

The embedded sensors 302 may also include a light sensor 306, a proximity sensor 308, a weather monitor 310, a motion sensor 312, a microphone 314, or any other sensor capable of capturing real world data. In addition, sensors may be combined in other devices, such as a camera and speakers integrated in mobile phones or mobile computers. Each of the embedded sensors 302 may capture real world data for use in the composite reality environment. For example, the weather monitor may record the presence of precipitation in the real world 110 to create real world data 106 that may be integrated with a virtual reality environment.

At block 316, aspects of the real world data captured by the embedded sensors 302 are analyzed. In one embodiment, the various embedded sensors 302 analyze aspects of the real world data, such as by parsing the data they record to create desired data. Alternatively, the real world data module 212 or structural extraction module 218 may infer aspects of the real world data captured by the embedded sensors 302. For example, the weather monitor 310 may capture many details about the weather such as temperature, barometric pressure, and the amount of precipitation. This information may be converted in real world data 106 that can readily be used by the composite reality engine 102, such as by analyzing the obtained data to determine the type of precipitation (e.g., rain or snow).

At block 318, the composite reality engine 102 transforms the analyzed real world data for placement into the composite reality environment. The transformation process may be generated by the composite reality application 216 by applying the instructions from the structure extraction module 214. For example, the real world data 106 recorded by the weather monitor 310, which is analyzed at the block 316 and determined to be snow, may be transformed by the composite reality application 216 to represent snow in a virtual reality environment. The transformation process may include changing the intensity of the falling snow based, for example, on a location within the virtual reality environment, such that the snow may not be represented inside buildings or may be more intense in unobstructed open air locations.

In another embodiment, the block 316 may infer additional elements from the real world data captured by the embedded sensors 302. The additional elements may then be applied in the composite reality environment in the block 318. For example, the real world light level may be measured at a sunny spot by the light sensor 306. The light level may then be appropriately transformed to generate additional elements such as the light values in sunny, shady, indoor, or other locations in the composite reality environment. This may increase the realism of the composite reality environment as the real world effects of season, time of day, clouds and environmental factors directly influence the virtual world aspects of the composite reality environment.

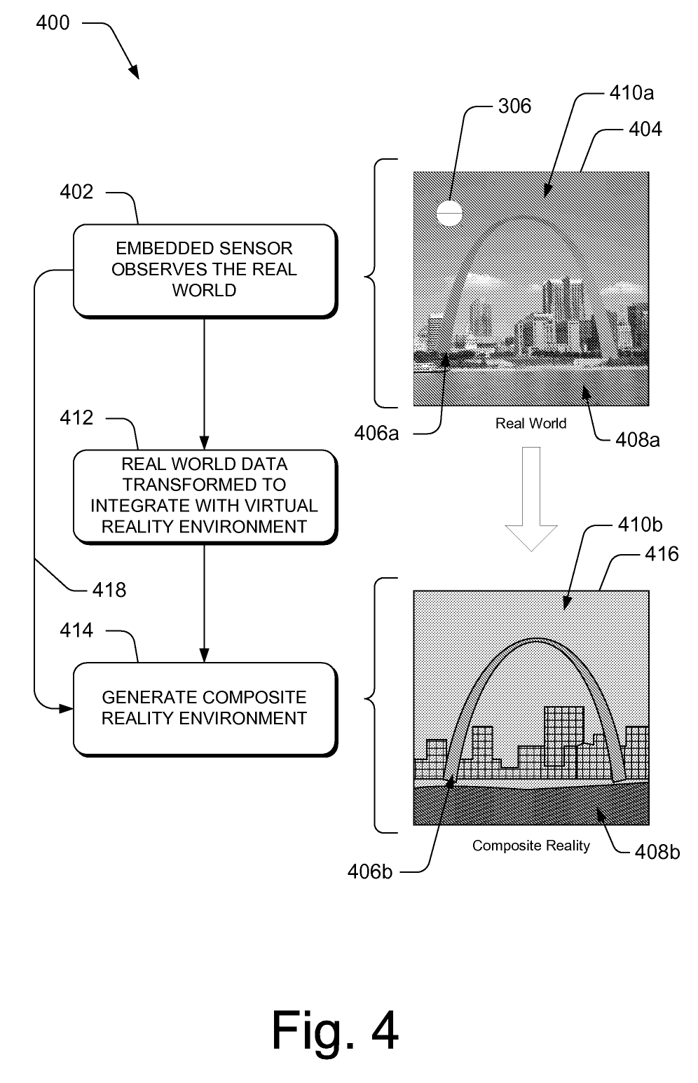

FIG. 4 illustrates a method 400 suitable for creating a composite reality environment that implements portions of the real world environment in the composite reality environment. At block 402, the embedded sensors observe the real world. The composite reality engine 102 uses the real world data 106 captured by the embedded sensors 108 including objects, states, events, and information. For example, the light sensor 306 may be placed in a remote location within the real world 404. The light sensor 306 may measure the light levels in a surrounding location near the light sensor, such as the light levels on building 406a, water 408a, and the sky 410a.

At block 412, the composite reality engine transforms the real world data to integrate with the virtual reality environment. At block 414, the composite reality engine generates a composite reality environment that integrates data captured from the remote location in the real world 404 with a virtual realty environment to form a composite reality environment 416. The composite reality environment 416 may resemble aspects of the real world, such as by including buildings 406b and water 408b resembling the real world. The real world data may be also used to enhance the virtual reality environment, such as by integrating the light levels measured in the real world for a specific time and location. Therefore, the composite reality environment 416 may include buildings 406b, water 408b, and a sky 410b that are enhanced using real world data captured by the light sensor 306.

The buildings 406b, water 408b, sky 410b and other components or objects in the composite reality environment 416 may also include colorization measured in the real world 404. To further clarify, if a color sensor 306 observed the Chicago River on St. Patrick's Day and integrated transformed colorization data into a composite reality environment, the river in the composite reality environment generated for that day would be colored green to reflect the dye Chicagoans place in their river each year in celebration of this holiday.

At the block 414, the real world data may be placed within (or rendered with) the virtual reality environment by applying transformation techniques at the block 412 which may be implemented by the composite reality engine 102. The composite reality engine 102, via the composite reality application 216, may use other techniques to place the real world data into the composite reality environment.

In some instances the method 400 may bypass the block 412 via a route 418, when it is not necessary to transform the real world data before inserting it into the virtual reality environment. For example, a real world image may be implemented as an image that is placed directly into the composite reality environment at the block 408, which includes renderings of the virtual reality environment. In another example application without a transformation function, a video stream supplied by the camera 304 of FIG. 3 may be used by the virtual reality engine 102 without any transformation of the real world data at the block 404.

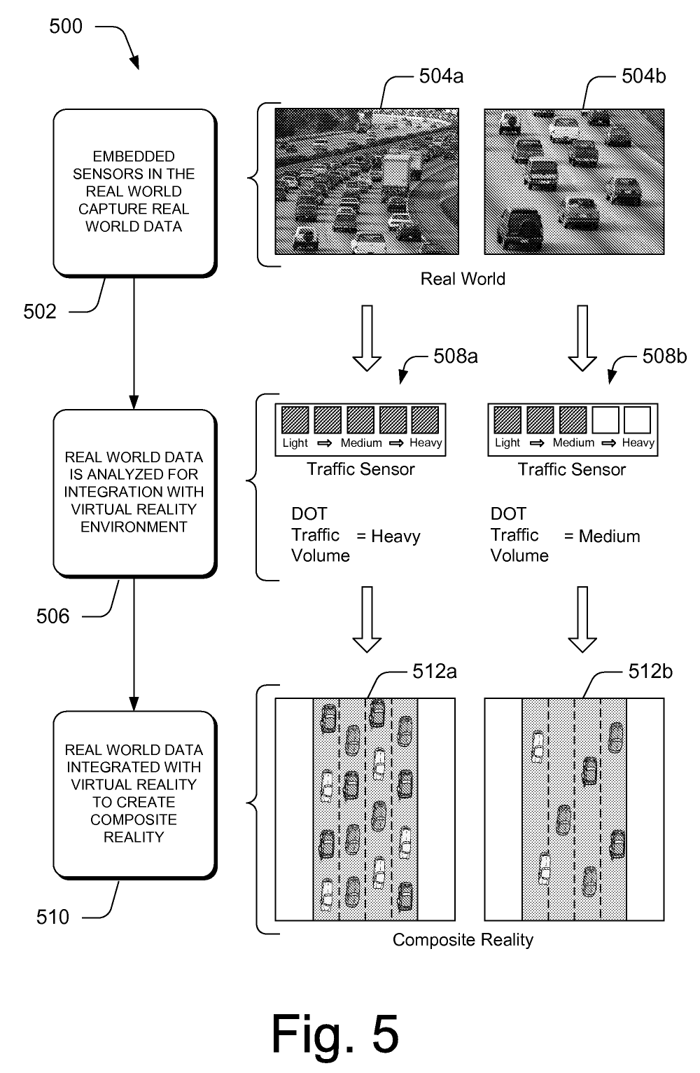

FIG. 5 illustrates a method 500 that allows a user to experience and interact in a composite reality environment that contains aspects of a virtual reality environment and the real world. The composite reality engine provides a method to develop new types of games which are directly influenced by real world events. The events of the real world are selectively incorporated with portions of the virtual reality game environment. The objects, states, events, and information captured or derived from the real world data using the methods discussed in FIGS. 3 and 4 are used to create game entities which influence the behavior and interaction of game players. The uncertainty and limited control of real world events may add interest to the game. Further, the method 500 may allow the use of real world light, colorization, or other sensor captured aspects in the virtual reality game and thus save a game developer from generating detailed game art. This may save time and money in game development.

The method 500 includes block 502 where embedded sensors 108 in the real world 110 capture real world data 106. For example, in a real world location, embedded sensors 108 may observe traffic levels of a highway (i.e., the number of cars on a section of road during a time interval) at a first time 504a and a second time 504b. The embedded sensors 108 may include physical strips which count cars as they drive over the counting strip, image capturing devices, or other known methods of systematically capturing real world data for traffic levels.

At block 506, the real world data is analyzed for integration with a virtual reality environment. For example, if the traffic levels at the first time 504a and the second time 504b are captured in an image. The image may require analysis to determine a numerical or symbolic level representative of the traffic level. The analysis may determine the real world traffic at the first time 504a has a heavy traffic volume 508a while the traffic at the second time represents a medium traffic volume 508b. Traffic volume data may be provided by the Department of Transportation (DOT) or other providers that measure the real world with embedded sensors 108. The embedded sensors 108 in the real world may detect changes in aspects of the real world observed by embedded sensors, such as changes in light levels, traffic conditions, or weather conditions.

At block 510, real world data is integrated with a virtual reality environment to create a composite reality environment. A user may interact in the composite reality environment and experience aspects of both the real world (e.g., traffic and driving conditions) while interacting with virtual reality objects, such as the virtual reality generated traffic. For example, in a first composite reality scene 512a, the user may experience traffic volumes observed in the real world at the first time 504a. When the traffic volume changes in the real world, such as at the second time 504b, the composite reality may adjust the virtual reality environment based on the real world data, thus reducing the number of virtual reality cars in a second composite reality scene 512b.

As discussed above with reference to FIG. 1, the composite reality engine may provide real world data in a real-time, near real-time, or archived occurrence application. For example, the scene 504 may be the current traffic (real-time), the traffic recently captured by the embedded sensors (near real-time), or traffic from a specific time in the past (archived occurrence). In some embodiments, the user interacting with the composite reality environment may select a day and time to drive a virtual car through real world data of traffic, such as on New Year's Day of the past year in New York City, and thus use archived real world data.

In another example, traffic data may be transformed and merged into a virtual reality environment. Real world traffic volumes at an intersection may be mapped by the composite reality engine 102 into a virtual driving game utilizing virtual reality engine renderings of streets and real world data of traffic congestion and flow. Therefore, the method 500 may allow a user in the composite reality environment to experience real world events in the context of the virtual reality environment.

### Alternative Embodiments

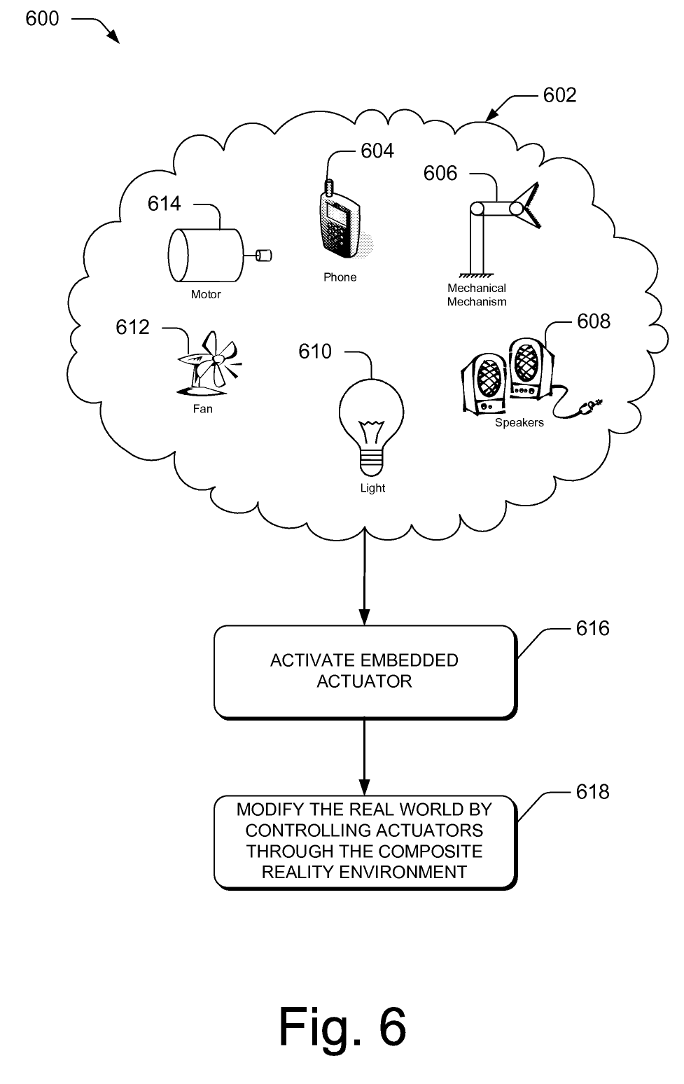

FIG. 6 illustrates a method 600 of providing the embedded actuators in the real world for manipulation by a user from the composite reality environment. In an embodiment of the disclosure, the composite reality engine 102 in connection with the user interface 114 may allow the user to interact with the real world 110.

The method 600 includes any number of embedded actuators 602 situated in the real world. The embedded actuators 602 may include a phone 604, a mechanical mechanism 606, speakers 608, a light 610, a fan 612, a motor 614, or any other actuator controllable by the user through a user interface. The embedded actuators 602 situated in the real world are capable of inducing actions within the real world. For example, the embedded actuators 602 may influence various objects in the real world by moving them or causing a reaction. This may include manipulating objects monitored by the embedded sensors 302 as described in FIG. 3.

At a block 616, the user activates the embedded actuators 602 through the user interface 114. The embedded actuators 602 may be in communication with the composite reality engine 102 and operably controlled by the user interface 114. The user may control actions in the composite reality environment by sending a signal to the embedded actuators 602, which in turn modify the real world as shown at a block 618. The composite reality environment may then depict a modification to the real world based on the manipulation by the user.

In an example gaming application, the embedded actuator 602 may be a mechanical mechanism 606 used to move a specific object in the real world which is of interest to a game and associated with the composite reality engine. In another example, the user may reorient a camera providing video data to the game, such as camera 304, using the motor 614 connected to the camera 304 to change the field of view recorded by the camera. The embedded actuator 602 may be used in a real-time application or may operate with a delayed response.

The embedded actuator 602 may receive a command from the user through the user interface 114. The command can be processed by the composite reality engine 102 and then later implemented in the real world to create a delayed response. The user may realize the effect of the embedded actuator 602 at a later time or session when interacting in the composite reality environment. For example, in a role playing application where the users interact in the composite reality environment on a continual basis, either a delayed or real-time response from the embedded actuators 602 in the real world may provide the users with increased interest in the role playing application.

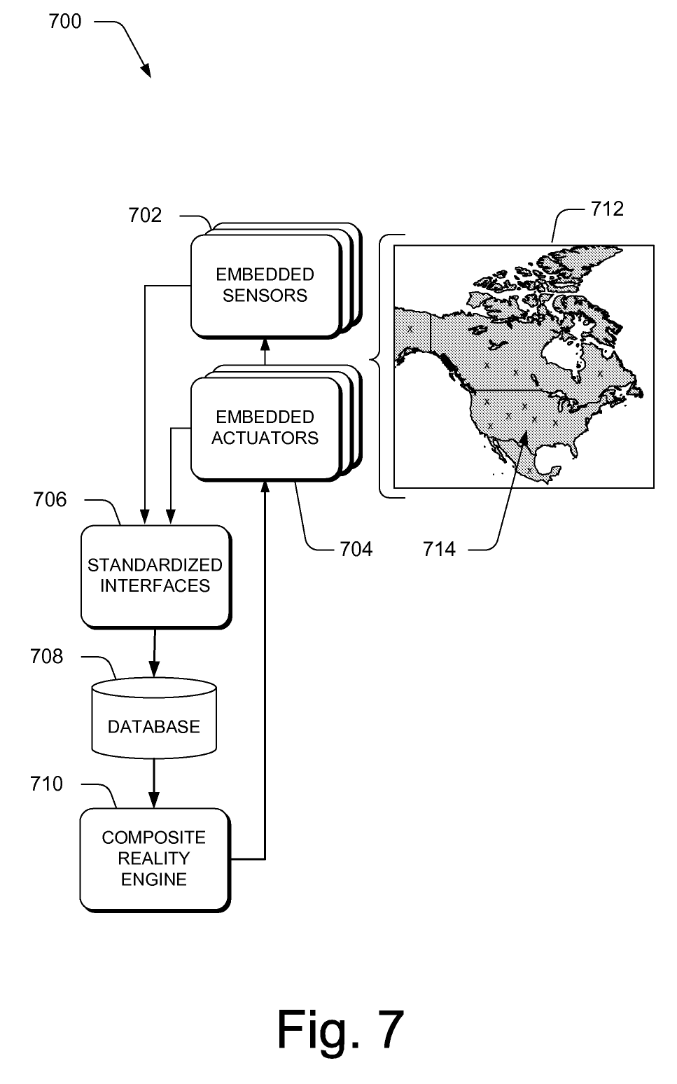

FIG. 7 illustrates a method 700 of capturing real world data from the embedded sensors and the embedded actuators and providing the data to the composite reality engine. The method 700 may enable sharing of the embedded sensors 702 and the embedded actuators 704 from multiple operators. The embedded sensors 702 and the embedded actuators 704 may be operated by multiple operators, and thus ownership of the sensors and the actuators may be fragmented making it difficult to share resources. For example, a person may desire to contribute images, weather information, or other data to a database used by the composite reality engine, and thus provide real world data to users in the composite reality environment. Such data contributors may join and leave the system at various times or only provide data for certain times and therefore, the availability of the embedded sensors 108 and embedded actuators 116 may dynamically change over time.

The method 700 may provide standardized interfaces 706, such as standardized schemas and/or associated computational interfaces, that enable multiple embedded sensors 702 to contribute content from the real world to a database 708 for processing by a composite reality engine 710. The standard interfaces 706 may also enable commands from the composite reality engine 710 to be distributed to multiple embedded actuators 704. Further, as described above in FIG. 6, the embedded actuators 704 may be configured with the embedded sensors 702.

The embedded sensors 702 and embedded actuators 704 may be selected by the user in the composite reality environment, such as when the user selects desired content or controls an actuator. The embedded sensors 702 and embedded actuators 704 may have differing associated costs charged by their respective providers. The costs may be designed to include monetary payments, reciprocity agreements of resource usage, or advertisement driven revenues. As an illustration, a car racing game may allow a number of players to race in single composite reality environment using real world data from a particular location. A first provider may provide the road maps for that location with the background scenery while a second provider may provide the real-time traffic congestion for the selected roads. The traffic congestion may be provided, for example, by existing Department of Transportation sensors currently used along established highways and roads. Content from one or both providers may be included in the game using the standardized interfaces provided by the composite reality engine.

The embedded sensors 702 and embedded actuators 704 may be located anywhere in the real world, as depicted by the map 712. Specific data points 714 (e.g., location data) for the embedded sensors 702 and embedded actuators 704 may be entered in the database 708 along with other useful information such as the time and date of the data entry and location

### CONCLUSION

The above-described techniques (e.g., methods, devices, systems, etc.) pertain to enhancing virtual reality environments using real world data to produce a composite reality environment. Although the techniques have been described in language specific to structural features and/or methodological acts, it is to be understood that the appended claims are not necessarily limited to the specific features or acts described. Rather, the specific features and acts are disclosed as exemplary forms of implementing such techniques.

What is claimed is:

1. A method comprising:
capturing real world data with an embedded sensor;
rendering virtual reality data;
transforming at least one aspect of the real world data to form transformed real world data;
integrating the transformed real world data and the virtual reality data into a composite reality environment; and
facilitating user interaction with the composite reality environment.

2. The method of claim 1, wherein capturing real world data using an embedded sensor includes sensing environmental conditions in the real world.

3. The method of claim 1, wherein integrating the transformed real world data into the composite reality environment includes:
capturing updated real world data; and
transforming at least one aspect of the updated real world data to form updated transformed real world data;
integrating the updated transformed real world data into the composite reality environment.

4. The method of claim 1, wherein facilitating user interaction with the composite reality environment includes retrieval of archived real world data.

5. The method of claim 4, wherein retrieval of archived real world data allows selection of a specific time period for the real world data.

6. The method of claim 1, wherein transforming at least one aspect of the real world data includes extracting colorization data from an image.

7. The method of claim 1, wherein transforming at least one aspect of the real world data includes extracting weather conditions from sensor data for integration into a virtual reality environment.

8. The method of claim 1, wherein facilitating user interaction includes providing an online gaming application.

9. The method of claim 1, wherein integrating the transformed real world data includes integrating the transformed real world data into the composite reality environment approximately simultaneously with capturing the real world data.

10. The method of claim 1, wherein facilitating user interaction with the composite reality environment includes enabling the user to effect changes in the real world environment by activating embedded actuators situated remotely in the real world.

11. A system comprising:
sensor to capture real world data;
a virtual reality engine to create virtual reality data; and
a composite reality engine to transform the real world data captured by the sensor and integrate the transformed real world data with the virtual reality data to generate a composite reality environment.

12. The system of claim 11, wherein the sensor captures time, date, and location data associated with the real world data.

13. The system of claim 11, wherein the system further comprises:
a user interface to facilitate user interact with the composite reality environment including aspects of both the real world data and the virtual reality data.

14. The system of claim 13, wherein the system further comprises:
an actuator in communication with the composite reality engine for manipulating the real world through the composite reality environment.

15. The system of claim 11, wherein the sensors transmit the real world data to a database in communication with the composite reality engine.

16. The system of claim 15 further comprising standardized schemas and associated computational interfaces to enable the sensor to contribute content from the real world to at least one of the database or the composite reality engine.

17. The system of claim 16, wherein the standardized schemas provide a cost associated with usage of at least one of the sensor or an actuator.

18. The system of claim 16, wherein the standardized schemas and associated computational interfaces enable dynamic availability of embedded sensors in the real world.

19. One or more computer readable media comprising computer-executable instructions that, when executed by a computer, perform acts comprising:
receiving real world data and virtual reality data;
transforming the real world data to enhance aspects of the virtual reality data;
integrating the transformed real world data with the virtual reality data to create composite reality data; and
generating a composite reality environment from the composite reality data.

20. One or more computer readable media as in claim 19 further comprising providing embedded actuators configured to modify the real world.
